(19) United States
(12) Patent Application Publication
(10) Pub. No.: US 2016/0297960 A1
(43) Pub. Date: Oct. 13, 2016

(54) EPOXY COMPOSITION CONTAINING CORE-SHELL RUBBER

(71) Applicant: BLUE CUBE IP LLC, Midland, MI (US)

(72) Inventors: Fabio Aguirre-Vargas, Lake Jackson, TX (US); Christopher D. Rainey, Bay City, MI (US)

(21) Appl. No.: 15/102,701

(22) PCT Filed: Dec. 8, 2014
(86) PCT No.: PCT/US2014/069001

§ 371 Date: Jun. 8, 2016

Related U.S. Application Data
(60) Provisional application No. 61/915,655, filed on Dec. 13, 2013.

(51) Int. Cl. C08L 63/00; C08J 3/00; C08G 59/24; C09D 163/00

(52) U.S. Cl. CPC C08L 63/00; C09D 163/00; C08J 3/005; C08G 59/245; C08G 59/24; C08J 2363/00; C08J 2463/00; C08J 2409/06; C08L 2205/02; C08L 2205/03; C08L 2207/53

(57) ABSTRACT

The present disclosure provides a curable epoxy composition that includes 1,4-cyclohexanedimethanol (CHDM) epoxy resin; at least one other epoxy resin other than the CHDM epoxy resin; a core shell rubber (CSR) particles; and a curing agent. The curable epoxy composition includes 5 weight percent (wt. %) to 10 wt. % of the CSR particles and 10 wt. % to 20 wt. % of the CHDM epoxy resin, where the wt. % is based on the total weight of the curable epoxy composition. The curable epoxy composition does not include a solvent.

### TECHNICAL FIELD

The present disclosure relates generally to epoxy compositions and more specifically to epoxy compositions containing core-shell rubber.

### BACKGROUND

Epoxy resins are globally used in a wide range of corrosion protection applications because of their excellent bonding strength, versatility and excellent adhesion properties to various substrates. In addition, epoxy resins have high chemical and heat resistance as well as low shrinkage upon cure and, thus, are dimensionally stable. These superior performance characteristics, coupled with outstanding formulating versatility and reasonable costs, have gained epoxy resins wide acceptance as materials of choice for a multitude of protective coatings applications.

One important limitation of epoxy resins is their rigid structure which can make the coating prone to rapid crack propagation when stress applied on the coatings system cannot be absorbed. Once the coating integrity is compromised its ability to protect the substrate from corrosion is diminished and costly re-patching work to replace the damage coatings has to be done to avoid further corrosion of the asset.

Several approaches have been taken in attempts to release coatings stress and avoid crack formation or propagation. The most common ones are to plasticize the coating system or modified the epoxy resin with fatty acids or mono phenolic compounds to make it more flexible. These approaches tend to reduce the coating, modulus, glass transition temperature (Tg) as well as its barrier properties and hence are not frequently used in high corrosive environments.

Toughening agents like block copolymers, core-shell rubber (CSR) particles and carboxyl-terminated butadieneacrylonitrile copolymers (CTBM) have been used in epoxy coating systems to reduce the brittleness with limited effect on modulus, Tg or the barrier properties of the coating. However, there are several shortcomings in the use of conventional toughening agents such as formulation dependent toughening effect in the case of block copolymers, high viscosity in the case of CSR particles and CTBM dispersions in liquid epoxy resins that would ultimately affect the viscosity of the coating formulation.

For example, EP 1632533 provides a method for producing an epoxy resin composition containing an epoxy resin and core-shell type rubber particles dispersed in the epoxy resin. Although the composition described EP 1632533 may help to improve coating impact resistance and flexibility, the amount of core-shell rubber in the dispersion is limited to not more than 25% by weight due the high viscosity build up. Since the minimum among of CSR in the dry coating has to be minimum 5% by weight in the dry coating to achieve the desired impact resistance formulators would need to use a high amount of the composition described in EP 1632533 limiting the use of other components in the formulation and increasing the formulation viscosity to more than 10,000 cPs at 25° C., which requires multiplural spray systems with heating components to apply the coating. Both the low concentration of CSR in the resin and high viscosity of the formulation based on the CSR dispersion composition described EP 1632533 increases the coating formulation cost and limits its use to applications where expensive multiplural spray systems with heating components can be afforded. Similar issues are common when CTBM dispersions in liquid epoxy resins are used in coatings.

So, what is needed is a low viscosity epoxy resin that can be used to significantly enhance the impact resistant and flexibility of epoxy coatings a without compromising the cost or the viscosity of the coating formulation.

### SUMMARY

The present disclosure has surprisingly found that a predetermined weight percentage of a specific core-shell rubber (CSR) particle in a low viscosity epoxy resin can be used to significantly enhance the impact resistant and flexibility of epoxy coatings a without compromising the cost or the viscosity of the coating formulation. Thermosets prepared from the curable epoxy composition of the present disclosure provides a low viscosity epoxy compositions containing core-shell rubber, where the composition might be suitable, among other things, for coatings having improved properties such as increased flexibility and increased impact resistance.

Generally the present disclosure provides a curable epoxy composition that includes 1,4-cyclohexanedimethanol (CHDM) epoxy resin, at least one other epoxy resin other than the CHDM epoxy resin, a core shell rubber (CSR) particles, and a curing agent. The composition includes 5 weight percent (wt. %) to 10 wt. % of the CSR particles and 10 wt. % to 20 wt. % of the CHDM epoxy resin, where the wt. % is based on the total weight of the curable epoxy composition. The CHDM epoxy resin has an epoxide equivalent weight (EEW) in a range from 128 to 170. The curable epoxy composition does not include a solvent.

The CSR particles are prepared by i) carrying out an emulsion polymerization of monomers in an aqueous dispersion medium to create the CSR particles; ii) coagulating the CSR particles to form a slurry; iii) dewatering the slurry to form dewatered CSR particles; and iv) drying the dewatered CSR particles to provide the CSR particles. The CSR particles have a core formed from monomers selected from the group consisting of methylmethacrylate butadiene styrene (MBS) monomers, methacrylate-acrylonitrile-butadiene-styrene (MABS) monomers or a combination thereof. The CSR particles also have a shell formed from an acrylic polymer, an acrylic copolymer or a combination thereof.

The at least one other epoxy resin other than the CHDM epoxy resin is selected from the group consisting of a bisphenol F-based epoxy resin, an epoxy novolac, a bisphenol A based epoxy resin, a dimer acid or fatty acid modified bisphenol A epoxy or a combination thereof. The curing agent is selected from the group consisting of an ethylene amine, a cycloaliphatic amine, a Mannich base, a polyamide, a phenalkamine, or a combination thereof.

The curable epoxy composition of the present disclosure can be used to prepare a cured thermoset coating. For example, the curable epoxy composition of the present disclosure can be used to prepare a coated article. The coated article can include a substrate and a cured thermoset coating on the substrate, where the cured thermoset coating is formed by curing the curable epoxy composition of the present disclosure. The process for preparing a curable epoxy composition includes admixing CHDM epoxy resin, at least one other epoxy resin other than the CHDM epoxy resin, the CSR particles, and the curing agent. The curable epoxy composition does not include a solvent.

### BRIEF DESCRIPTION OF THE DRAWINGS

FIG. 1 is a graph illustrating a viscosity Profile of XCM-53 (25% PARALOID EXL 2650a in DER 354).

FIG. 2 is a graph illustrating a viscosity Profile of XCM-54 (33% of PARALOID EXL 2650a and PARALOID TMS-2670 in CHDM Resin).

### DETAILED DESCRIPTION

The present disclosure has surprisingly found that a predetermined weight percentage of specific core-shell rubber (CSR) particles in low viscosity epoxy resin can be used to significantly enhance the impact resistant and flexibility of epoxy coatings without compromising the cost or the viscosity of the coating formulation. The curable epoxy composition of the present disclosure provides a low viscosity epoxy composition that contains CSR particles, where the composition is suitable for, among other things, coatings having improved properties such as increased flexibility and increased impact resistance.

Generally the present disclosure provides a curable epoxy composition that includes 1,4-cyclohexanedimethanol (CHDM) epoxy resin, at least one other epoxy resin other than the CHDM epoxy resin, CSR particles, and a curing agent. For the embodiments, the CSR particles can be dispersed in the the CHDM epoxy resin, as provided herein. For the embodiments, at least 50% of the CSR particles are prepared by a process comprising: I) carrying out an emulsion polymerization of monomers in an aqueous dispersion medium to form thermoplastic CSR particles; II) coagulating the thermoplastic CSR particles to form a slurry; III) dewatering the slurry to form dewatered CSR particles and IV) drying the dewatered CSR particles to form dried CSR particles. The CHDM epoxy resin and the at least one other epoxy resin other than the CHDM epoxy resin do not dissolved the CSR particles.

### Epoxy Resins

For the various embodiments, the at least one other epoxy resin other than the CHDM epoxy resin can be selected from the group consisting of a bisphenol F-based epoxy resin, an epoxy novolac, a bisphenol A based epoxy resin, a dimer acid or fatty acid modified bisphenol A epoxy or a combination thereof. Non-limiting examples of these epoxy resins, along with others, which may be used to disperse the CSR particles for the production of the curable epoxy composition of the present disclosure include but are not limited to the CHDM epoxy resin in combination with diglycidyl ethers of diols such as bisphenol A, brominated bisphenol A, bisphenol F, bisphenol K (4,4′-dihydroxybenzophenone), bisphenol S (4,4′-dihydroxyphenyl sulfone), hydroquinone, resorcinol, 1,1-cyclohexanebisphenol, ethylene glycol, propylene glycol, diethylene glycol, dipropylene glycol, butanediol, hexanediol, cyclohexanediol, 1,4-bis(hydroxymethyl)benzene, 1,3-bis(hydroxymethyl)benzene, 1,4-bis(hydroxymethyl)benzene, 1,4-bis(hydroxymethyl)cyclohexane, and 1,3-bis(hydroxymethyl)cyclohexane; diglycidyl esters of dicarbaxylic acids such as hexahydrophthalic acid; diepoxy compounds such as cyclooctene diepoxide, divinylbenzene diepoxide, 1,7-octadiene diepoxide, 1,3-butadiene diepoxide, 1,5-hexadiene diepoxide and the diepoxide of 4-cyclohexenecarbocylate 4-cyclohexenylmethyl ester; and glycidyl ether derivatives of novolacs such as phenol novolac, cresol novolac, and bisphenol A novolac. The epoxy resin used with the CHDM epoxy resin may also be selected from commercially available epoxy resin products such as for example, D.E.R. 737, D.E.R. 741, D.E.R. 331®, D.E.R.332, D.E.R. 383, D.E.R. 354, D.E.R. 580, D.E.N. 425, D.E.N. 431, D.E.N. 438, D.E.R. 736, or D.E.R. 732 epoxy resins available from The Dow Chemical Company. Mixtures of two or more of these other epoxy resin other than the CHDM epoxy resin may be used as well.

The CHDM epoxy resin may include, for example, 1,4-cyclohexanedimethanol diglycidyl ether (CHDM DGE) having the following chemical structure, Structure (I):

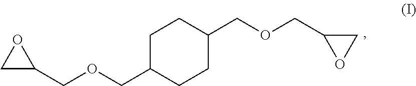 [SMILES: C1CC(COCC2CO2)CCC1COCC1CO1]

which is commercially avaialble as Epodil 757, Denacol EX 216L, Heloxy 107, Polypox R11 and D.E.R. 737.

The epoxy equivalent weight (EEW, defined herein as the average molecular weight divided by the number of epoxy groups per molecule) of the CHDM epoxy resin may, for example, be from 128 to 170, but will usually be not higher than 170. In order to reach a desirable EEW or other properties, the epoxy resin (with or without CSR particles) may also be combined with one or more mono, di- or multifunctional nucleophilic compounds. These compounds can be added to the epoxy resins before or during the addition of the CSR particles. Non-limiting examples of these nucleophilic compounds include fatty acids, Dimer fatty acids, Cardanol, Cardol.

Generally, the amount of the CHDM epoxy resin used to prepare the curable epoxy composition of the present disclosure, may be for example, range from 10 wt. % to 95 wt. % in one embodiment, from 10 wt. % to 90 wt. % in another embodiment, from 20 wt. % to 80 wt. % in still another embodiment; and from 30 wt. % to 70 wt. % in yet another embodiment, based on the total weight of the epoxy resins. Generally, the amount of the at least one other epoxy resin other than the CHDM epoxy resin used to prepare the curable epoxy composition of the present disclosure may be for example, from 10 wt. % to 90 wt. % in one embodiment, from 20 wt. % to 80 wt. % in another embodiment; and from 30 wt. % to 70 wt. % in still another embodiment, based on the total weight of the epoxy resins.

### Core Shell Rubber (CSR) Particles

The curable epoxy composition of the present disclosure also includes CSR particles. At least 50% of the CSR particles are prepared by a process that includes i) carrying out an emulsion polymerization of monomers in an aqueous dispersion medium to create the CSR particles; ii) coagulating the CSR particles to form a slurry; iii) dewatering the slurry to form dewatered CSR particles; and iv) drying the dewatered CSR particles to provide the CSR particles. This process is described in more details in WO 03/016404.

The emulsion polymerization to form the CSR particles may be performed in the presence or absence of a known emulsifying agent. In an embodiment, the polymerization can occur with a dispersant or emulsifying agent. Specifically, they include, for example, nonionic emulsifiers or dispersants such as alkali metal salts or ammonium salts of various acids, for example, alkyl or aryl sulfonic acids typically represented by dioctyl sulfosuccinic acid or dodecylbenzene sulfonic acid, alkyl or aryl sulfonic acid typically represented by dodecyl sulfonic acid, alkyl or aryl ether sulfonic acid, alkyl or aryl substituted phosphoric acid, alkyl or aryl ether substituted phosphoric acid, or N-alkyl or aryl sarcosinic acid typically represented by dodecyl sarcosinic acid, alkyl or aryl carboxylic acid typically represented by oleic acid or stearic acid, alkyl or aryl ether carboxylic acids, and alkyl or aryl substituted polyethylene glycol, and dispersant such as polyvinyl alcohol, alkyl substituted cellulose, polyvinyl pyrrolidone or polyacrylic acid derivative. They may be used alone or in combination of two or more.

In an embodiment, the CSR particles are isolated from the polymer latex formed by the emulsion polymerization process via coagulation. This is done by converting the polymer latex into a slurry by coagulation so that the polymer fine particles constituting the latex are caused to form an agglomerate thereof. The slurry is then dewatered by any suitable method known in the art, and subsequently dried by any method known in the art.

The CSR particles include both a core and a shell. The core of the CSR particles may be formed from monomers selected from the group consisting of methylmethacrylate butadiene styrene (MBS) monomers, methacrylate-acrylonitrile-butadiene-styrene (MABS) monomers or a combination thereof. The shell of the CSR particles may be formed from an acrylic polymer, an acrylic copolymer or a combination thereof. The preferred CSR particle has a styrene butadiene rubber core (e.g., formed from MBS monomers) and a shell of acrylic polymer or acrylic copolymer. Examples of other useful compounds for forming the core include ABS (acrylonitrile-butadiene-styrene), ASA (acrylate-styrene-acrylonitrile), acrylics, SA EPDM (styrene-acrylonitrile grafted onto elastomeric backbones of ethylene-propylene diene monomer), MAS (methacrylic-acrylic rubber styrene), and the like and mixtures thereof. The CSR particles generally have a particle size of at least 50 μm. In another embodiment, the core shell rubber particles have a particle size in the range of from 70 μm to 130 μm.

Examples of CSR particles prepared by emulsion polymerization and isolated via coagulation followed by dewatering and drying for use in the present disclosure include PARALOID™ EXL-3600ER, PARALOID™ EXL-2602, PARALOID™ EXL-2603, PARALOID™ EXL-2678, PARALOID™ EXL-2600ER, PARALOID™ -EXL-2655, PARALOID EXL 2650a, PARALOID™ EXL-2620, PARALOID™ EXL-2691A, PARALOID™ EXL-3691A and PARALOID™ TMS 2670, all of which are commercially available from The Dow Chemical Company. Other useful CSR particles that can be used in combination with those described above include PARALOID™ EXL-3808, PARALOID EXL™ 2300G, PARALOID™ EXL-2388, PARALOID™ EXL-2314, PARALOID™ EXL-3361, PARALOID™ EXL-2330, PARALOID™ EXL-3330, PARALOID™ EXL-2335 (each commercially available from The Dow Chemical Company), GRC-310, Metablen W5500, Kaneka MX-210, Kumho HR181 or a combination thereof.

The amount of CSR particles dispersed in the epoxy resins discussed herein can be determined by targeted amounts of CSR particles and the epoxy resins. Preferably, the curable epoxy composition includes 5 weight percent (wt. %) to 10 wt. % of the CSR particles and 10 wt. % to 20 wt. % of the CHDM epoxy resin, where the wt. % is based on the total weight of the curable epoxy composition.

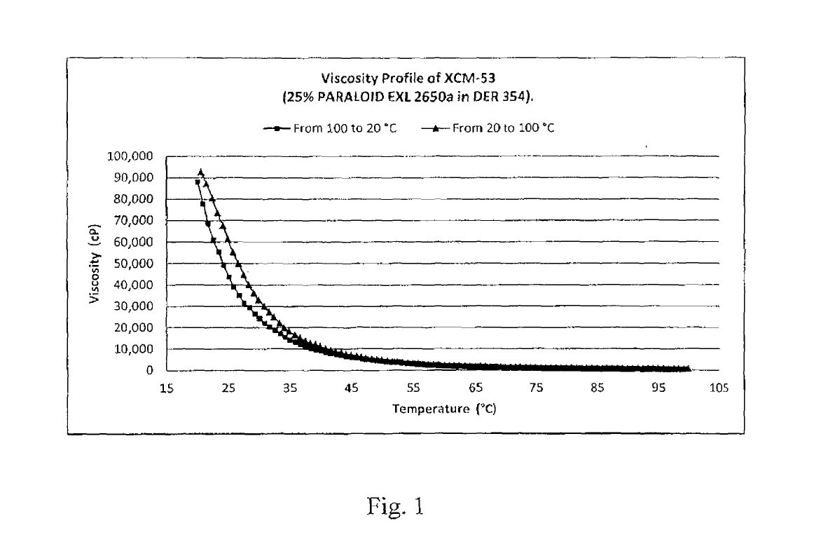

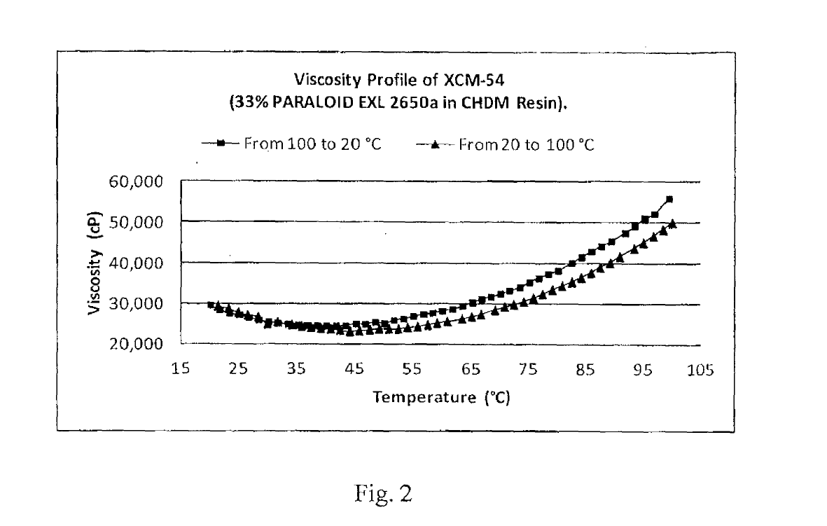

As discussed, at least 50% of the CSR particles can be prepared by emulsion polymerization and isolated via coagulation followed by dewatering and drying, as described above. Without wishing to be bound by theory, it is believed that if more than 50% of CSR is prepared by a spray drying process (instead of by dewatering and drying), the residual dispersant or emulsifying agent agents on the CSR would significantly increase the viscosity of the CSR dispersion. It is also believed that CHDM epoxy resin (e.g., CHDM DGE) and other resins like Neopentyl glycol diglycidyl ether commercially avalilable as Epodil 749, Polypox R 14, Heloxy 68 o-Cresol glycidyl ether commercially available as Araldite DY-K, Epodil 742 and Heloxy 62 can migrated to core of the CSR particles without dissolving it or the highly crosslinked acrylic shell. Therefore, the CHDM epoxy resin could have a swelling effect on the CSR particles specially when the CSR dispersion is heat up to 100° C., which translates into an increase in viscosity with temperature (FIG. 2). However, this swelling effect is expected to be reversible when the CSR dispersion is cold down and is not expected to affect the performance of the CSR particles. The migration of the CHDM epoxy resin into the CSR core is expected to reduce the glass transition temperature of the core and broad the temperature range where the CSR shows a rubbery behavior. Other epoxy resins like D.E.R. 741, D.E.R. 332, D.E.R. 331, D.E.R. 338 and D.E.R. 354 do not seem to migrated into the CSR particles and exhibit an inverse correlation between temperaure and viscosity (FIG. 1) while other epoxy resins like C12-C14 alkyl glycidyl ether commercially available as Epoxide 8, Epodil 748, D.E.R. 721 epoxy resins can dissolve the CSR particles.

The curable epoxy composition of the present disclosure also includes a curing agent. The curing agent can be selected from the group consisting of an amide curing agent, an amine curing agent or a combination thereof. Other optional additives known to the skilled artisan can be included in the curable epoxy composition such as for example a curing catalyst and other additives that do not adversely affect the final coating product made from the composition.

In general, the curing agent, also referred to as a hardener or cross-linking agent, which is blended with the epoxy resin compounds to prepare the curable epoxy composition of the present disclosure may comprise, for example, a conventional amine curing agent known in the art useful for including in a curable epoxy composition. For example, the amine curing agent, useful in the curable epoxy composition, may be selected, for example, but are not limited to, primary amine compounds, secondary amine compounds, tertiary amine compounds or a combination thereof.

For example, in one embodiment, the curing agent of the present disclosure may include at least one amine compound such as an ethylene amine, a cycloaliphatic amine, a Mannich base, a polyamide, a phenalkamine or a combination thereof. Another preferred embodiment of the amine compound useful in the present disclosure may include an amidoamine, a polyamide, a phenalkamine or a combination thereof. Other curing agents that can be used in the present disclosure may include for example curing agents based on isophorone diamine, bisaminomethylcyclohexane, bis(aminocyclohexyl)methane, metaxylene diamine, diaminocyclohexane, and ethyleneamines; adducts of any one or more of the aforementioned amines with epoxy resins; amides of any one or more of the aforementioned amines with fatty acids and dimer acids; Mannich bases of any one or more of the aforementioned amines or a combination thereof.

The concentration of the amine compound present in the curable epoxy composition of the present disclosure may range generally in an equivalent ratio of amine NH:epoxy functionality of from 0.5:1 to 1.5:1 in one embodiment, from 0.6:1 to 1.4:1 in another embodiment, from 0.7:1 to 1.3:1 in still another embodiment, from 0.8:1 to 1.2:1 in yet another embodiment, and from 0.8:1 to 1.1:1 in even still another embodiment. Outside the above concentrations, the resulting coating film properties may suffer due to poor network formation from a stoichiometric imbalance.

In preparing the curable epoxy composition of the present disclosure, optional additives can be added to the curable epoxy composition including for example compounds that are normally used in epoxy coating formulations known to those skilled in the art for preparing curable compositions and thermosets. For example, the optional additives may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

Other optional additives that may be added to the curable epoxy composition of the present disclosure may include, for example, an extender, a pigment, a flexibilizing agent, a processing aide or a combination thereof. Additional optional additives include, but are not limited to, a catalyst to facilitate the reaction between the epoxy compound and the curing agent used, other resins such as a phenolic resin that can be blended with the epoxy resins of the curable epoxy composition, other epoxy resins different from the epoxy resins of the present disclosure, other curing agents, accelerators, fillers, pigments, toughening agents, flow modifiers, adhesion promoters, diluents, stabilizers, plasticizers, catalyst de-activators, flame retardants, wetting agents, rheology modifiers, other similar additives/components used in epoxy coatings or a combination thereof.

Examples of optional other curing agents different from the amine curing agent useful in the present disclosure may include any of the co-reactive or catalytic curing materials known to be useful for curing epoxy resin based compositions. Such co-reactive curing agents include, for example, polyamine, polyamide, polyaminoamide, dicyandiamide, polymeric thiol, polycarboxylic acid and anhydride, and any combination thereof or the like. Suitable catalytic curing agents include tertiary amines; quaternary ammonium halides; quaternary phosphonium halides or carboxylates; Lewis acids such as boron trifluoride; and any combination thereof or the like. Other specific examples of co-reactive curing agent include diaminodiphenylsulfone, styrene-maleic acid anhydride (SMA) copolymers or a combination thereof. Among the conventional co-reactive epoxy curing agents, amines and amino or amido containing resins and phenolics are preferred.

Generally, the amount of one or more optional additives, when used in the present disclosure, may be, for example, from 0.01 wt. % to 10 wt. % in another embodiment; from 0.1 wt. % to 5 wt. % in still another embodiment; and from 1.0 wt. % to 2.5 wt. % in yet another embodiment, where the wt. % is based on the total weight of the curable epoxy composition.

The process for preparing the curable epoxy composition of the present disclosure includes admixing the epoxy resins compound described above; the CSR particles; the curing agent and, optionally, any other optional additives such as at least one cure catalyst or other optional additives described herein. The curable epoxy composition of the present disclosure does not include a solvent. In other words, no solvent is intentionally added to the curable epoxy composition of the present disclosure. As a result, the amount of solvent present in the curable epoxy composition of the present disclosure is zero. In an alternative embodiment, a solven could be optionally used with the curable epoxy composition of the present disclosure.

The admixing of the curable epoxy composition of the present disclosure can be achieved by blending, in known mixing equipment, the epoxy resins, the CSR particles, the curing agent, and optionally any other desirable optional additives. Any of the above-mentioned optional additives, for example a curing catalyst, may be added to the composition during the mixing or prior to the mixing to form the composition.

All the compounds of the curable epoxy composition are typically admixed and dispersed at a temperature enabling the preparation of the coating epoxy composition. For example, the temperature during the mixing of all components used in making the curable epoxy composition may be generally from 5° C. to 90° C. in one embodiment, and from 25° C. to 50° C. in another embodiment. In one embodiment, advantageously, the conditions above can be modified as desired such that the curable epoxy composition can be made without adversely affecting the final product upon heating.

The preparation of the curable epoxy composition of the present disclosure, and/or any of the steps thereof, may be a batch or a continuous process. The mixing equipment used in the process may be any vessel and ancillary equipment well known to those skilled in the art.

The curable epoxy composition advantageously has several improved properties. For example, the blended curable epoxy composition has viscosity of less than 10,000 centipoise (cP) in one embodiment, from 4,000 cP to 8,000 cP in another embodiment, from 5,000 cP to 7,000 cP in yet another embodiment. The viscosity can be measured according to ASTM D-2196 at 25° C. using a Brookfield DVIII Ultra; Spindle # 34 at 50 rotations per minute.

The process of the present disclosure includes forming a cured thermoset coating prepared from the curable epoxy composition of the present disclosure. For example, the curable epoxy composition can be used to form a coated article having a substrate, where the cured thermoset coating is on the substrate, and where the cured thermoset coating is formed by curing the curable epoxy composition of the present disclosure. In one embodiment, the curable epoxy composition can be cured to form a cured thermoset coating on the substrate of the article.

The process of curing of the curable epoxy composition may be carried out at a predetermined temperature and for a predetermined period of time sufficient to cure the curable epoxy composition. The curing process may be dependent on the hardeners used in the formulation. For example, the temperature of curing the curable epoxy composition may be generally from −10° C. to 200° C. in one embodiment; from 0° C. to 100° C. in another embodiment; and from 5° C. to 75° C. in still another embodiment.

Generally, the dry through time may be chosen between 1 hour to 48 hours in one embodiment, between 2 hours to 24 hours in another embodiment, and between 4 hours to 12 hours in still another embodiment. Below a period of time of 1 hour, the time may be too short to ensure sufficient time for mixing and application under conventional processing conditions; and above 48 hours, the time may be too long to be practical or economical.

### EXAMPLES

### Materials

| | Supplier/Trademark | | |
|---|---|---|---|
| Material | Owner | Description | Comments |
| D.E.R. ™ 354 | TDCC* | Bisphenol F diglycidyl ether | Epoxy Equivalent |
| | | | Weight (EEW) = 170 |
| CHDM epoxy resin | TDCC | 1,4-Cyclohexanedimethanol | EEW = 148 |
| | | diglycidyl ether | |
| FORTEGRA ™ 100 | TDCC | Block Copolymer Toughening | |
| | | agent | |
| PARALOID ™ EXL 2650A | TDCC | Methylmethacrylate Butadiene | |
| | | Styrene (MBS) Core Acrylic Shell | |
| | | Impact Modifier Core Shell Rubber | |
| | | (CSR) | |
| PARALOID ™ TMS 2670 | TDCC | (MBS) Core Acrylic Shell Impact | |
| | | Modifier Core Shell Rubber (CSR) | |
| BYK ®-P 104S | BYK Additives | Wetting and dispersing additive | Food contact |
| | | | applications |
| BYK ®-A 501 | BYK Additives | Silicone-free air release additive | Food contact |
| | | | applications |
| Ti-Pure ® R-706 Titanium | DuPont | Rutile titanium dioxide pigment | |
| Dioxide | | | |
| IMSIL ® A-10 | Unimin Specialty | Microcrystalline silica Extender | Median Particle Size |
| | minerals | | 2.4 μm |
| Nytal ® 300 | R. T. Vanderbilt | Microcrystalline talc Extender | High purity, 5- |
| | | | Hegman magnesium |
| | | | hydrosilicate |
| ChemCure ® | Polystar | Low viscosity polyamide hardener | ANEW = 97 |
| 140ChemCure ® 140 | | for use in low VOC coatings | |
| DMP-30 | Air Products | 2,4,6-Tris-[Dimethylaminomethyl]- | accelerates |
| | | phenol | amine-epoxy |
| | | | reactions |
| D.E.H. 530D.E.H. 530 | TDCC | Modified Cycloaliphatic Amine | AEHW = 112 |
| Benzyl Alcohol | Emerald Performance | Benzyl Alcohol | Co-solvent/ |
| | Materials | | accelerator |

*The Dow Chemical Company

### Test Methods

| | Test Method to | |
|---|---|---|
| Property | Use | Comments |
| Viscosity | ASTM D562 | Use a Brookfield DVIII |
| | | Ultra; Spindle RV7 |
| | | @ 20 rpm |
| Pencil Hardness | ASTM D3363 | Ambient Cure (23° C.) |
| | | for 7 days |
| Dry Film Adhesion | ASTM D3359 | Use Method B |
| Impact Resistance | ASTM D2794 | Ambient Cure (23° C.) |
| | | for 7 days |
| Mandrel Bend | ASTM D522 | Ambient Cure (23° C.) |
| | | for 7 days |
| Taber Abrasion | ASTM D4060 | Ambient Cure (23° C.) |
| | | for 7 days |
| Tensile Properties | ASTM D638 - 10 | @ 0.05 millimeter |
| | | per second (mm/s) |
| Dry time recording | ASTM D5895 | |

### Comparative Examples A through D

Two separate weight percent (wt. %) amounts of the CSR particles (PARALOID EXL 2650A) with an epoxy resin (D.E.R.™ 354) were evaluated as shown in Table 1. The XCM-53 in Table 1 is a dispersion of 25 wt. % of the CSR particles (PARALOID™ EXL 2650A) and 75 wt. % of D.E.R.™ 354 based on the total weight of the mixture. Comparative Example A has 5 wt. % CSR particles, while Comparative Example B has 7.5 wt. % particles CSR. D.E.R.™ 354 without the CSR particles is used as Comparative Example C. FORTEGRA™ 100 thoughning agent is used as Comparative Example D. No solvent is used in the Comparative Examples A through D. The addition of solvent is optional and might be required to achieve better film formation in other formulations.

Mix each Part A and Part B of the Comparative Examples A through D using a DISPERMAT type high speed disperser (Model: Dispermat AE01-M-Ex & Dispermat CL 54) with a Cowles type blade at 2000 rotations per minute (RPM) for one hour to achieve a HEGMAN grind value of 6.5 to 7. Add the ingredients for each individual Part A and Part B in their respective sequence provided in Table 2 to the vortex during mixing for proper dispersion.

Mix Part A and Part B in a 1:1 stoichiometric ratio in a FlakTek speed mixer (Model: DAC 150) for approximately 3 minutes at 2500 RPM. Apply mixed coating formulations over steel substrates using a ten mil Bird bar. Cure each composition at 25° C. and 50% relative humidity in an Espec environmental chamber for seven days before testing the coating properties.

TABLE 1

| | Compar- | Compar- | Compar- | Compa- |
|---|---|---|---|---|
| | ative | ative | ative | ative |
| | Exam- | Exam- | Exam- | Exam- |
| | ple A | ple B | ple C | ple D |
| Grind Stage | wt. % | wt. % | wt. % | wt. % |
| D.E.R. ™ 354 | 32.21 | 24.17 | 31.84 | 46.21 |
| BYK ®-P 104S | 0.04 | 0.04 | 0.03 | 0.04 |
| BYK ®-A 501 | 0.10 | 0.09 | 0.09 | 0.09 |
| Ti-Pure ® R-706 | 4.65 | 4.52 | 4.53 | 4.51 |
| IMSIL ®A-10 | 1.39 | 1.35 | 1.36 | 1.35 |
| Nytal ® 300 | 0.87 | 0.84 | 0.84 | 0.84 |
| Let down Stage | | | | |
| D.E.R. ™ 354 | | | 19.28 | |
| FORTEGRA ™ 100 | | | | 7.50 |
| XCM-53 | 20.07 | 29.46 | | |
| Part A Total | 59.33 | 60.47 | 57.96 | 60.55 |
| Part B | | | | |
| ChemCure ® 140 | 11.98 | 11.65 | 13.45 | 11.62 |
| DMP30 | 0.09 | 0.09 | 0.09 | 0.09 |
| D.E.H. 530 | 17.28 | 16.79 | 17.49 | 16.76 |
| BYK ®-P 104S | 0.27 | 0.27 | 0.26 | 0.26 |
| BYK ®-A 501 | 0.06 | 0.06 | 0.06 | 0.06 |
| IMSIL ® A-10 | 6.64 | 6.45 | 6.47 | 6.44 |
| Nytal ® 300 | 2.25 | 2.19 | 2.19 | 2.18 |
| Benzyl Alcohol | 2.10 | 2.04 | 2.04 | 2.03 |
| Part B Total | 40.67 | 39.53 | 42.04 | 39.45 |
| Total weight % | 100 | 100 | 100 | 100 |
| % CSR in dry film | 5.0 | 7.5 | 0 | 0 |

Results in Table 2 are based on the solvent free formulations in Table 1. Coating properties were measured after 14 days ambient (23° C.) cure. Use these formulations to evaluate the 25 wt. % PARALOID EXL 2650a in D.E.R.™ 354 (XCM-52 in Comparative Examples A and B) versus FORTEGRA™ 100 (Comparative Example D) and D.E.R.™ 354 without a CSR (Comparative Example C).

As shown in Table 2, the Part A and Part B mixed viscosity at 50° C. of Comparative Examples A and B containing CSR particles increased with the CSR particles content. The CSR particles did not affect the pencil hardness as FORTEGRA™ 100 did in Comparative Example D. X-hatch adhesion was not adversely impacted by the CSR particles.

Direct impact resistance for Comparative Examples A and B was two times that of Comparative Example C. Comparative Example B had the highest indirect impact resistance of Examples in Table 2. Conical Bend flexibility was improved by the addition of CSR (Comparative Examples A and B).

TABLE 2

| | Compar- | Compar- | Compar- | Compar- |
|---|---|---|---|---|
| | ative | ative | ative | ative |
| | Exam- | Exam- | Exam- | Exam- |
| | ple A | ple B | ple C | ple D |
| Toughening agent | PARALOID ™ | PARALOID ™ | | FORTEGRA ™ |
| | EXL 2650A | EXL 2650A | | 100 |
| CSR Content in | 5.0 | 7.5 | 0.0% | 0.0 |
| the dry film | | | | |
| (wt. %) | | | | |
| Part A + B Mixed | 2000 | 2800 | 1000 | 1000 |
| viscosity (cP) at | | | | |
| 50° C. | | | | |
| Toughening agent | 5.0% | 7.5% | 0.0% | 7.5% |
| Content (wt. %) | | | | |
| Film Thickness | 5.1 | 5.2 | 4.9 | 6.2 |
| (mils) | | | | |
| Pencil Hardness | 2H | 2H | 3H | HB |
| X-Hatch Adhesion | 5B | 5B | 4B | 5B |
| Impact Resistance - | 40 | 40 | 20 | 40 |
| direct (in-lbs) | | | | |
| Impact Resistance - | 10 | 20 | <10 | <10 |
| indirect (in-lbs) | | | | |
| Conical Bend Crack | 10 | 13 | 119 | — |
| length, (mm) | | | | |
| Max Tensile strain | 5.49 | 5.79 | 2.89 | 2.1 |
| (%) | | | | |
| Max Tensile stress | 450.30 | 398.56 | 495.60 | 268 |
| (kgf/cm²) | | | | |
| Toughness | 218.28 | 175.62 | 117.37 | 45 |
| (kgf/cm²) | | | | |
| Max extension (mm) | 4.75 | 5.16 | 2.21 | 1.58 |
| Modulus (kgf/cm²) | 19,306 | 18,217 | 22,708 | 16,626 |
| Taber abrasion, | 80.70 | 76.90 | 73.5 | — |
| mg lost | | | | |

### Examples 1 through 4 and Comparative Examples E and F

Formulations in Table 3 evaluate two CSR particles (PARALOID EXL 2650A and PARALOID™ TMS 2670) dispersed in a CHDM epoxy resin. In Table 3, “XCM-54 with EXL” is a dispersion of 33 wt. % of the CSR particles (PARALOID™ 2650A) and 67 wt. % of CHDM epoxy resin based on the total weight of the dispersion, and “XCM-54 with TMS” is a dispertion of 33 wt. % of the CSR particles (PARALOID™ TMS 2670) and 67 wt. % of CHDM epoxy resin based on the total weight of the dispertion. Examples 1 and 3 have 5 wt. % CSR particles, while Examples 2 and 4 have 7.5 wt. % CSR particles in the final dry film composition. D.E.R.™ 354 without CSR particles is used as Comparative Example E and CHDM epoxy resin without CSR particles is used as Comparative Example F, as shown in Table 3. No solvent is used in Examples 1 through 4 or in Comparative Examples E and F. The addition of solvent is optional and might be required to acchive better film formation in other formulations.

Part A and Part B of the Examples 1 through 4 and Comparative Examples E and F were mixed using a DISPERMAT type high speed disperser (Model: Dispermat AE01-M-Ex & Dispermat CL 54) with a Cowles type blade at 2000 rotations per minute (RPM) for one hour to achieve a HEGMAN grind value of 6.5 to 7. The ingredients for each individual Part A and Part B were added in their respective sequence provided in Table 3 to the vortex during mixing for proper dispersion.

Part A and Part B were mixed in a 1:1 stoichiometric ratio in a FlakTek speed mixer (Model: DAC 150) for approximately 3 minutes at 2500 RPM. The mixed coating formulations were applied over steel substrates using a ten mil Bird bar. Each composition was cured at 25° C/50% relative humidity in an Espec environmental chamber for seven days before testing the coating properties.

TABLE 3

| | Comparative | Comparative | | | | |
|---|---|---|---|---|---|---|
| | Example E | Example F | Example 1 | Example 2 | Example 3 | Example 4 |
| Toughening | | | PARALOID ™ | PARALOID ™ | PARALOID ™ | PARALOID ™ |
| agent Type | | | EXL | EXL | TMS | TMS |
| | | | 2650A | 2650A | 2670 | 2670 |
| | wt. % | wt. % | wt. % | wt. % | wt. % | wt. % |
| Grind Stage | | | | | | |
| D.E.R. ™ 354 | 32.00 | 32.38 | 36.47 | 30.09 | 36.47 | 30.09 |
| BYK ®-P 104S | 0.03 | 0.04 | 0.04 | 0.04 | 0.04 | 0.04 |
| BYK ®-A 501 | 0.09 | 0.10 | 0.10 | 0.10 | 0.10 | 0.10 |
| Ti-Pure ® R-706 | 4.55 | 4.99 | 4.70 | 4.61 | 4.70 | 4.61 |
| IMSIL ® A-10 | 1.36 | 1.50 | 1.41 | 1.38 | 1.41 | 1.38 |
| Nytal ® 300 | 0.85 | 0.93 | 0.88 | 0.86 | 0.88 | 0.86 |
| Let down Stage | | | | | | |
| D.E.R. ™ 354 | 18.87 | | | | | |
| CHDM epoxy | | 16.38 | | | | |
| resin | | | | | | |
| XCM-54 with | | | 15.27 | 22.58 | | |
| EXL | | | | | | |
| XCM-54 with | | | | | 15.27 | 22.58 |
| TMS | | | | | | |
| Part A Total | 57.75 | 56.32 | 58.86 | 59.66 | 58.86 | 59.66 |
| Part B | | | | | | |
| ChemCure ® 140 | 13.51 | 12.87 | 12.12 | 11.89 | 12.12 | 11.89 |
| DMP 30 | 0.09 | 0.10 | 0.09 | 0.09 | 0.09 | 0.09 |
| D.E.H. 530 | 17.58 | 18.55 | 17.47 | 17.14 | 17.47 | 17.14 |
| BYK ®-P 104S | 0.26 | 0.29 | 0.28 | 0.27 | 0.28 | 0.27 |
| BYK ®-A 501 | 0.06 | 0.06 | 0.06 | 0.06 | 0.06 | 0.06 |
| IMSIL ® A-10 | 6.50 | 7.13 | 6.72 | 6.59 | 6.72 | 6.59 |
| Nytal ® 300 | 2.20 | 2.42 | 2.28 | 2.23 | 2.28 | 2.23 |
| Benzyl Alcohol | 2.05 | 2.25 | 2.12 | 2.08 | 2.12 | 2.08 |
| Part B Total | 42.25 | 43.68 | 41.14 | 40.34 | 41.14 | 40.34 |
| Total weight % | 100 | 100 | 100 | 100 | 100 | 100 |
| % CSR in dry | 0 | 0 | 5.0 | 7.5 | 5.0 | 7.5 |
| film | | | | | | |

Results in Table 4 are based on the solvent free formulations in Table 3. Table 4 illustrates the impact resistance of the coatings containing CSR particles were significantly improved when compared to Comparative Example E and Comparative Example F (using CHDM epoxy and DER 354 resin in the let donw stage, but lacking CSR particles). Comparing the results in Tables 2 and 4 suggests a synergistic effect between the CSR particles dispersed in the CHDM epoxy resin. Further, comparing Example 1 and Example 4 (Table 4, formulations containing CSR particles and CHDM epoxy resin) to Comparative Example A and Comparative Example B (Table 2, formulations containing CSR particles dispersed in DER 354; no CHDM resin is used) reveals that superior impact performance is achieved when both CSR particles are dispersed in CHDM epoxy resin.

TABLE 4

| | Comparative | Comparative | | | | |
|---|---|---|---|---|---|---|
| | Example E | Example F | Example 1 | Example 2 | Example 3 | Example 4 |
| Toughening agent Type | | | PARALOID ™ | PARALOID | PARALOID | PARALOID |
| | | | EXL | EXL | TMS 2670 | TMS 2670 |
| | | | 2650A | 2650A | | |
| CSR Content in the dry | 0.0% | 0.0% | 5.0% | 7.5% | 5.0% | 7.5% |
| film (wt. %) | | | | | | |
| CSR particles Viscosity | n/a | — | 5400 | 5400 | 4000 | 4000 |
| @ 50° C. (cP) | | | | | | |
| Part A viscosity @ 50° C. | 600 | — | 600 | 800 | 400 | 400 |
| (cP) | | | | | | |
| Part B viscosity @ 50° C. | 800 | — | 800 | 800 | 800 | 800 |
| (cP) | | | | | | |
| CSR Content in the dry | 0.0 | 0.0 | 5.0 | 7.5 | 5.0 | 7.5 |
| film (wt. %) | | | | | | |
| Film Thickness (mils) | 5.4 | | 5.9 | 5.9 | 4.4 | 3.1 |
| Pencil Hardness | 2H | HB | F | F | HB | HB |
| X-Hatch Adhesion | 4B | 5B | 4B | 5B | 5B | 5B |
| Impact Resistance - | 20 | 20 | 80 | 120 | 80 | 100 |
| Direct (in-lbs) | | | | | | |
| Impact Resistance - | 5 | <10 | 80 | 140 | 20 | 80 |
| indirect (in-lbs) | | | | | | |
| Conical Bend Crack | 152 | 25 | 0 | 0 | 0 | 0 |
| length (mm) | | | | | | |
| Mandrel Elongation (%) | 4 | 4 | 30 | 30 | 30 | 30 |
| Film Thickness (mils) | 5 | 3 | 6 | 6 | 4 | 3 |
| Max Tensile strain (%) | 3 | 5 | 8 | 13 | 5 | 7 |
| Max Tensile stress | 396 | 339 | 326 | 278 | 362 | 323 |
| (kgf/cm²) | | | | | | |
| Dry Time Recording | | | | | | |
| Stage A - Set to Touch | 4.3 | 4 | 5.7 | 2.5 | 6 | 6.8 |
| Time (hours) | | | | | | |
| Stage B - Tack Free | 10.5 | 9 | 8.6 | 6.1 | 8 | 9 |
| Time (hours) | | | | | | |
| Stage C - Dry Hard Time | 13.3 | 11 | 11 | 8.4 | 10.75 | 13.83 |
| (hours) | | | | | | |
| Stage D - Dry Through | N.A* | 15 | N.A | 10.80 | N.A | N.A |
| Time (hours) | | | | | | |

*Not achieved in 24 hours

This unexpected result seems to be related to the way the CSR particles are believed to interact with the CHDM epoxy resin. This belief is based on the following information. FIG. 1 illustrates the viscosity profile of XCM-53 (PARALOID EXL 2650a dispersion in DER 354), which is the expected inverse correlation between viscosity and temperature profile for liquids or dispersions. However, the viscosity profile of the XCM-54 (PARALOID EXL 2650a dispersion in CHDM epoxy resin) in FIG. 2, shows a different and an unexpected profile that could indicate swelling of the CSR particles by the CHDM epoxy resin as temperature goes up. The swelling of the CSR particles seems to be a reversible process when temperature goes down and does not seem to affect the performance of the CSR particles, on the contrary this phenomena seems to improve the performance of the CSR particles.

1. A curable epoxy composition, comprising:
1,4-cyclohexanedimethanol (CHDM) epoxy resin;
at least one other epoxy resin other than the CHDM epoxy resin;
a core shell rubber (CSR) particles; and
a curing agent.

2. The curable epoxy composition of claim 1, where the curable epoxy composition includes 5 weight percent (wt. %) to 10 wt. % of the CSR particles and 10 wt. % to 20 wt. % of the CHDM epoxy resin, where the wt. % is based on the total weight of the curable epoxy composition.

3. The curable epoxy composition of claim 1, where the CSR particles have a core formed from monomers selected from the group consisting of methylmethacrylate butadiene styrene monomers, methacrylate-acrylonitrile-butadiene-styrene monomers or a combination thereof.

4. The curable epoxy composition of claim 1, where the CSR particles have a shell formed from an acrylic polymer, an acrylic copolymer or a combination thereof.

5. The curable epoxy composition of claim 3, 4, where the CSR particles are prepared by:
i) carrying out an emulsion polymerization of monomers in an aqueous dispersion medium to create the CSR particles;
ii) coagulating the CSR particles to form a slurry;
iii) dewatering the slurry to form dewatered CSR particles; and
iv) drying the dewatered CSR particles to provide the CSR particles.

6. The composition of claim 1, wherein the at least one other epoxy resin other than the CHDM epoxy resin is selected from the group consisting of a bisphenol F-based epoxy resin, an epoxy novolac, a bisphenol A based epoxy resin, a dimer acid or fatty acid modified bisphenol A epoxy or a combination thereof.

7. The curable epoxy composition of claim 1, where the curing agent is selected from the group consisting of an ethylene amine, a cycloaliphatic amine, a Mannich base, a polyamide, a phenalkamine or a combination thereof.

8. The curable epoxy composition of claim 1, where the CHDM epoxy resin has an epoxide equivalent weight (EEW) in a range from 128 to 170.

9. The curable epoxy composition of claim 1, wherein the curable epoxy composition does not include a solvent.

10. The curable epoxy composition of claim 1, further including an extender, a pigment, a flexibilizing agent, a processing aide or a combination thereof.

11. A cured thermoset coating prepared from the curable epoxy composition of claim 1.

12. A coated article comprising:
a substrate; and
a cured thermoset coating on the substrate, wherein the cured thermoset coating is formed by curing the curable epoxy composition of claim 1.

13. A process for preparing a curable epoxy composition comprising admixing 1,4-cyclohexanedimethanol (CHDM) epoxy resin, at least one other epoxy resin other than the CHDM epoxy resin, a core shell rubber (CSR) particles, and a curing agent.

14. The process of claim 13, where the curable epoxy composition includes 5 weight percent (wt. %) to 10 wt. % of the CSR particles and 10 wt. % to 20 wt. % of the CHDM epoxy resin, where the wt. % is based on the total weight of the curable epoxy composition.

15. The process of claim 13, wherein the at least one other epoxy resin other than the CHDM epoxy resin is selected from the group consisting of a bisphenol F-based epoxy resin, an epoxy novolac, a bisphenol A based epoxy resin, a dimer acid or fatty acid modified bisphenol A epoxy or a combination thereof.

16. The process of claim 13, where the curing agent is selected from the group consisting of an ethylene amine, a cycloaliphatic amine, a Mannich base, a polyamide, a phenalkamine or a combination thereof

17. The process of claim 13, wherein the curable epoxy composition does not include a solvent.

18. The process of claim 13, further including curing the curable epoxy composition to form a cured thermoset coating.
